(19) United States
(12) Patent Application Publication
(10) Pub. No.: US 2020/0089200 A1
(43) Pub. Date: Mar. 19, 2020

(54) PRODUCTION MANAGEMENT SUPPORT APPARATUS AND PRODUCTION MANAGEMENT SUPPORT METHOD

(71) Applicant: FUJITSU LIMITED, Kawasaki-shi (JP)

(72) Inventors: Yosuke OOTAKE, Warabi (JP); Masahiro KOYA, Machida (JP); KOJI OGIWARA, Fukuoka (JP); Takehiro FUKUDA, Fukuoka (JP); Yoichi Fukunaga, Fukuoka (JP)

(73) Assignee: FUJITSU LIMITED, Kawasaki-shi (JP)

(21) Appl. No.: 16/554,683

(22) Filed: Aug. 29, 2019

(30) Foreign Application Priority Data
Sep. 13, 2018 (JP) 2018-171450

(51) Int. Cl. G05B 19/418

(52) U.S. Cl. CPC G05B 19/41865; G05B 2219/35081

(57) ABSTRACT

A production management support apparatus includes a memory, and a processor configured to, in response to receiving information indicating a design change of a product, display an image including both first information and second information, the first information regarding a first configuration of a first plurality of elements in the product before the design change, the second information regarding a second configuration of a second plurality of elements in the product after the design change, perform display of inventory information of, among the first plurality of elements, a first element whose inventory is predicted to be generated due to the design change, receive time information indicating a time when the design change is executed, and based on the received time information, modify the inventory information of the first element into a modified inventory information of the first element.

### CROSS-REFERENCE TO RELATED APPLICATION

This application is based upon and claims the benefit of priority of the prior Japanese Patent Application No. 2018-171450, filed on Sep. 13, 2018, the entire contents of which are incorporated herein by reference.

### FIELD

The embodiments discussed herein are related to production management support techniques.

### BACKGROUND

A manufacture management system for supporting tasks for planning of a production plan of a product is known. Related techniques are disclosed in, for example, Japanese Laid-open Patent Publication No. 2014-191605.

### SUMMARY

According to an aspect of the embodiments, a production management support apparatus includes a memory, and a processor configured to, in response to receiving information indicating a design change of a product, display an image including both first information and second information, the first information regarding a first configuration of a first plurality of elements in the product before the design change, the second information regarding a second configuration of a second plurality of elements in the product after the design change, perform display of inventory information of, among the first plurality of elements, a first element whose inventory is predicted to be generated due to the design change, receive time information indicating a time when the design change is executed, and based on the received time information, modify the inventory information of the first element into a modified inventory information of the first element.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an information processing system.

FIG. 2 is an example of a hardware configuration of a support server.

FIG. 3 is an example of a block diagram of a control device and a support server.

FIG. 4 is an example of a first process sequence diagram.

FIG. 5A illustrates an example of technical information.

FIG. 5B illustrates an example of production information.

FIG. 6 is an example of a second process sequence diagram.

FIG. 7 illustrates an example of new item information.

FIG. 8 is an example of a third process sequence diagram.

FIG. 9 illustrates an example of a list screen.

FIG. 10A illustrates an example of previous item information.

FIG. 10B illustrates an example of inventory information.

FIG. 11 is an example of a fourth process sequence diagram.

FIG. 12 illustrates another example of the list screen.

FIG. 13 illustrates an example of a first support screen before inventory information is changed.

FIG. 14 illustrates an example of new item information and previous item information for which inventory information is not generated.

FIG. 15 illustrates an example of a second support screen.

FIG. 16 is a diagram illustrating an example of operations for determining a specified date.

FIG. 17 illustrates an example of the first support screen after inventory information is changed.

FIG. 18 is an example of a fifth process sequence diagram.

### DESCRIPTION OF EMBODIMENTS

When the design of a product is to be changed, a review of a production plan of parts and materials used for the product (hereinafter the parts and materials being referred to as configuration items) is to be carried out in some cases. In such cases, tasks of reviewing a production plan are required of a manager who manages the production plan. For example, a task of determining a time when a design change of products and configuration items is to be made is required of the manager. If a manager is able to determine a suitable time when a design change is to be made, a situation may be suppressed where manufacturing company to which the manager belongs has excessive inventories of configuration items before the design change and products manufactured from the configuration items. For example, dead inventories are reduced.

However, determining a time when a design change is to be made has a problem in that this is very difficult for a manager and imposes a burden on the manager. In some cases, depending on the time determined by the manager, bulk inventories of configuration items and products are left. Conversely, in other cases, depending on the time determined by the manager, inventories of configuration items and products are insufficient to cause delayed delivery to customers who purchase products. A conventional manufacture management system does not suffice for supporting the manager to determine a time when the design change is performed.

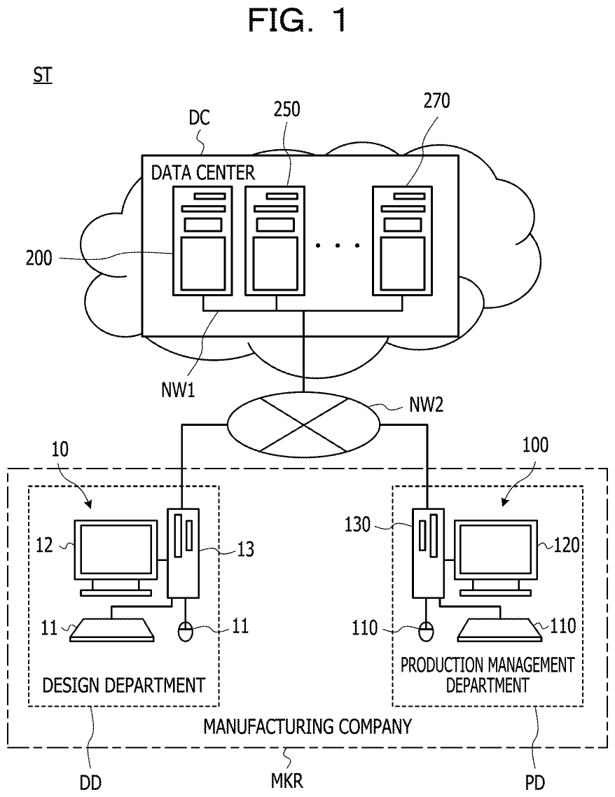

FIG. 1 is a diagram illustrating an example of an information processing system ST. The information processing system ST includes a design terminal 10 and a management terminal 100. In FIG. 1, personal computers (PCs) are illustrated as examples of the design terminal 10 and the management terminal 100; however, the design terminal 10 and the management terminal 100 may be smart devices such as tablet terminals. The information processing system ST also includes a support server 200, a technical management server 250, and a production management server 270. The support server 200 is an example of a production management support apparatus. Components of the information processing system ST may be changed as appropriate. For example, the components of the information processing system ST may be the management terminal 100 and the support server 200. The components of the information processing system ST may also be the support server 200, the technical management server 250, and the production management server 270.

The design terminal 10 is a terminal device that is operated by a designer belonging to a manufacturing company MKR. The designer designs products manufactured by the manufacturing company MKR and configuration items produced by the manufacturing company MKR. The design terminal 10 includes an input device 11, a display device 12, and a control device 13. The input device 11 and the display device 12 are coupled to the control device 13. The design terminal 10 is installed in a design department DD and the like of the manufacturing company MKR.

In response to a request for a design change of a product directly or indirectly from a customer of the manufacturing company MKR to a designer, the designer operates the input device 11 to initiate a design change of configuration items used in the product. If the designs of the configuration items are changed, the configuration items whose designs have been changed are used in the product. Therefore, the design of the product is changed in conjunction with the designs of configuration items. The customer of the manufacturing company MKR may be a business customer or may be an individual customer.

For example, when the designer is requested to change the design of a product, the control device 13 accesses the technical management server 250 in response to an operation of the designer on the input device 11 and obtains technical information about the design of the product and configuration items (hereinafter referred to as design information) among various types of technical information managed by the technical management server 250. The design information includes the design drawings, hierarchy levels, and so on of the product and configuration items. Upon obtaining the design information, the control device 13 displays the obtained design information on the display device 12. Based on the design information displayed on the display device 12, the designer changes the design of configuration items. When the designer inputs an instruction to complete the design change by using the input device 11, the control device 13 transmits design information after the design change to the technical management server 250.

The management terminal 100 is a terminal device that is operated by a manager belonging to the manufacturing company MKR. The manager manages the production volume, production schedule, and the like of a product manufactured by the manufacturing company MKR and configuration items for use in the product. The management terminal 100 includes an input device 110, a display device 120, and a control device 130. The input device 110 and the display device 120 are coupled to the control device 130. The management terminal 100 is installed in a production management department PD and the like of the manufacturing company MKR.

The manager operates the management terminal 100 to regularly or irregularly perform a task for determining a time when a design change of a product and configuration items is to be made. For example, in response to a first operation of the manager on the input device 110, the control device 130 accesses the support server 200 and displays on the display device 120 a list screen for confirming a list of cases where a design change of a product is requested. Each time the technical management server 250 receives design information after a design change, the support server 200 updates the display content of the list screen. In response to a second operation of the manager on the input device 110, the control device 130 accesses the support server 200 and displays a first support screen in which new item information including design information and the like after a design change and previous item information including design information and the like before the design change are arranged side by side for each of products and configuration items common to the new item information and the previous item information. Since the new item information and the previous item information are arranged side by side on the first support screen, the manager may compare the new item information with the previous item information. The manager operates the first support screen displayed on the display device 120 and confirms information thereon to determine a time when a design change is to be made.

The support server 200, the technical management server 250, and the production management server 270 are all installed in a data center DC providing cloud services. At least one of the technical management server 250 and the production management server 270 may be installed in another data center (not illustrated), which is different from the data center DC. As will be discussed in more detail later, the support server 200 is a server device that supports the manager in determining a time when a design change is to be made. The technical management server 250 is a server device that manages various types of technical information including design information. The technical management server 250 may be implemented by software, for example, such as a product life cycle management (PLM) package. Upon receiving design information after a design change, the technical management server 250 requests the support server 200 to investigate the degree of influence (for example, delivery delay and the like) of the design change on the product. The production management server 270 is a server device that manages production information including the inventory amounts and production schedules of configuration items and products, the order situations of the products, and the deadlines for delivering the products to customers. The production management server 270 may be implemented by software, for example, such as an enterprise resource planning (ERP) package.

The design terminal 10, the management terminal 100, the support server 200, the technical management server 250, and the production management server 270 are coupled to each other via a communication network NW1 and a communication network NW2. The communication network NW1 is, for example, a local area network (LAN). The communication network NW2 is, for example, the Internet. Accordingly, both the design terminal 10 and the management terminal 100 may be coupled to the support server 200, the technical management server 250, and the production management server 270 by using the communication network NW1 and the communication network NW2.

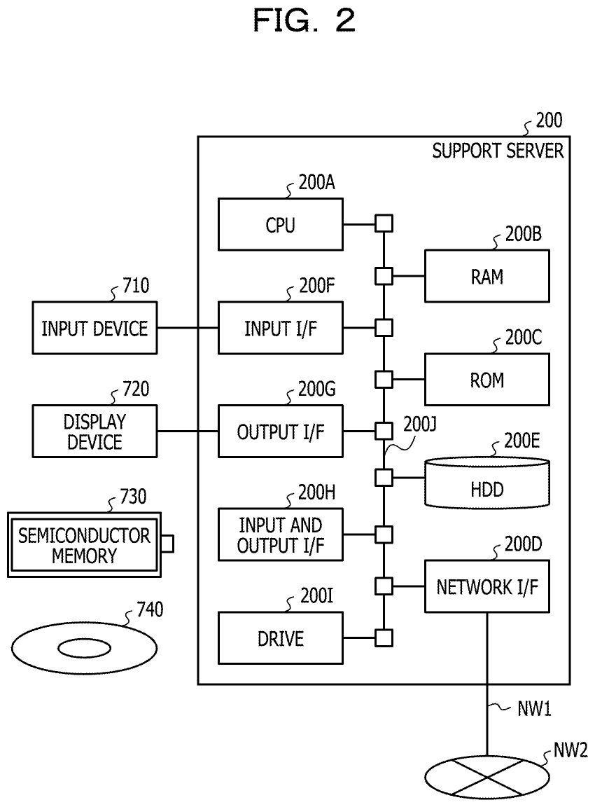

With reference to FIG. 2, a hardware configuration of the support server 200 will be described next. Each of the control device 13 and the control device 130 described above has a hardware configuration similar to that of the support server 200 and therefore redundant description thereof is omitted. Each of the technical management server 250 and the production management server 270 described above has a hardware configuration similar to that of the support server 200 and therefore redundant description thereof is omitted.

FIG. 2 is an example of a hardware configuration of the support server 200. As illustrated in FIG. 2, the support server 200 includes at least a central processing unit (CPU) 200A that serves as a hardware processor, a random access memory (RAM) 200B, a read-only memory (ROM) 200C, and a network interface (I/F) 200D. The support server 200 may include at least one of a hard disk drive (HDD) 200E, an input I/F 200F, an output I/F 200G, an input and output I/F 200H, and a drive device 2001, as required. The CPU 200A to the drive device 2001 are coupled to each other by an internal bus 200J. For example, the support server 200 may be implemented by a computer. Instead of the CPU 200A, a micro processing unit (MPU) may be used as a hardware processor.

An input device 710 is coupled to the input I/F 200F. The input device 710 is, for example, a keyboard, a mouse, or the like. The input device 11 and the input device 110 described above are similar to the input device 710. A display device 720 is coupled to the output I/F 200G. The display device 720 is, for example, a liquid crystal display. The display device 12 and the display device 120 described above are similar to the display device 720. A semiconductor memory 730 is coupled to the input and output I/F 200H. The semiconductor memory 730 is, for example, a Universal Serial Bus (USB) memory, a flash memory, or the like. The input and output I/F 200H reads a program or data stored in the semiconductor memory 730. The input I/F 200F and the input and output I/F 200H include, for example, a USB port. The output I/F 200G includes, for example, a display port.

A portable recording medium 740 is inserted into the drive device 2001. The portable recording medium 740 is, for example, a removable disc such as a compact disc (CD)-ROM or a digital versatile disc (DVD). The drive device 2001 reads a program or data recorded on the portable recording medium 740. The network I/F 200D includes, for example, a LAN port, a communication circuit, and the like. The network I/F 200D is coupled via the communication network NW1 to the communication network NW2.

In the above-described RAM 200B, a program stored in the ROM 200C or the HDD 200E is temporarily stored by the CPU 200A. In the RAM 200B, a program recorded on the portable recording medium 740 is temporarily stored by the CPU 200A. By executing the stored program including a plurality of instructions, the CPU 200A achieves various types of functions described later and executes various types of processes described later. The program may be in accordance with process sequence diagrams described later.

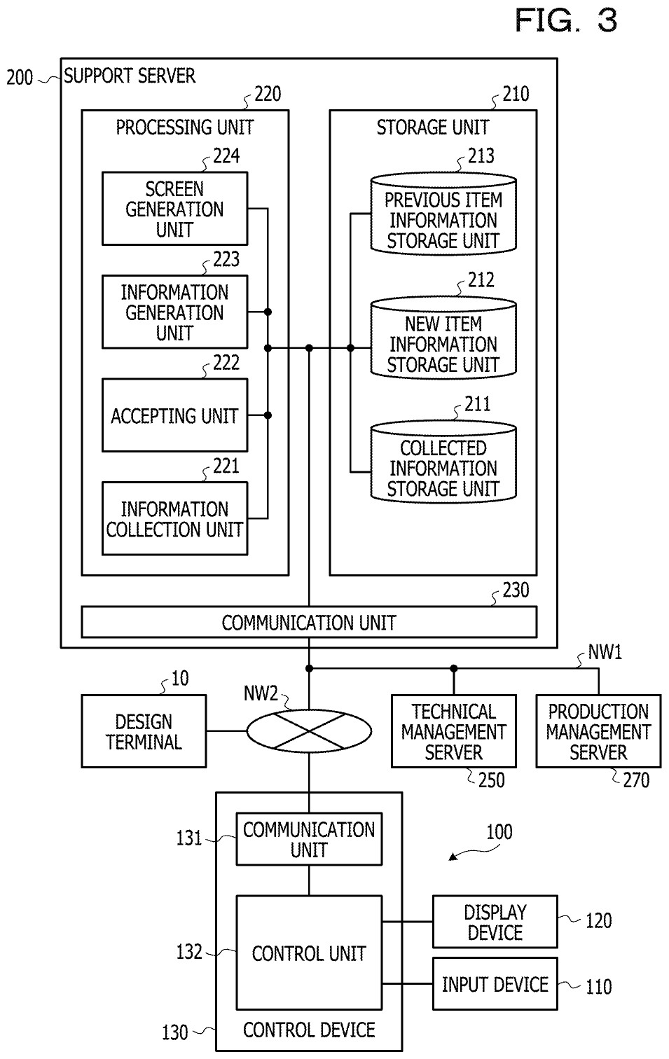

With reference to FIG. 3, functional configurations of the control device 130 and the support server 200 will be described next. FIG. 3 is an example of a block diagram of the control device 130 and the support server 200. In FIG. 3, main functional units of the control device 130 and the support server 200 are illustrated. As illustrated in FIG. 3, the control device 130 includes, as components thereof, a communication unit 131 and a control unit 132. The communication unit 131 may be implemented by the network I/F 200D described above. The control unit 132 may be implemented by the CPU 200A described above. The communication unit 131 and the control unit 132 are functionally coupled to each other. The functions that are achieved by the components of the control device 130 will be described in detail during description of operations of the control device 130.

The support server 200 includes a storage unit 210, a processing unit 220, and a communication unit 230. The storage unit 210 may be implemented by at least one of the RAM 200B and the HDD 200E described above. The processing unit 220 may be implemented by the CPU 200A described above. The communication unit 230 may be implemented by the network I/F 200D described above. The storage unit 210, the processing unit 220, and the communication unit 230 are functionally coupled to each other.

The storage unit 210 includes, as components thereof, a collected information storage unit 211, a new item information storage unit 212, and a previous item information storage unit 213. The processing unit 220 includes, as components thereof, an information collection unit 221, an accepting unit 222, an information generation unit 223, and a screen generation unit 224. The components of the processing unit 220 cooperate with the components of the storage unit 210 to perform various processes.

For example, the information collection unit 221 regularly collects technical information from the technical management server 250 via the communication unit 230. The information collection unit 221 regularly collects production information from the production management server 270 via the communication unit 230. The information collection unit 221 saves the collected technical information and production information in the collected information storage unit 211. In addition, the information collection unit 221 may regularly collect various types of information from servers other than the technical management server 250 and the production management server 270 and save the collected information in the collected information storage unit 211. Examples of the servers other than the technical management server 250 and the production management server 270 include a server device having software, such as a manufacturing execution system (MES) package, implemented therein. Thus, the collected information storage unit 211 stores a wide variety of information. The functions that are achieved by the components of the processing unit 220 will be described in detail during description of operations of the support server 200.

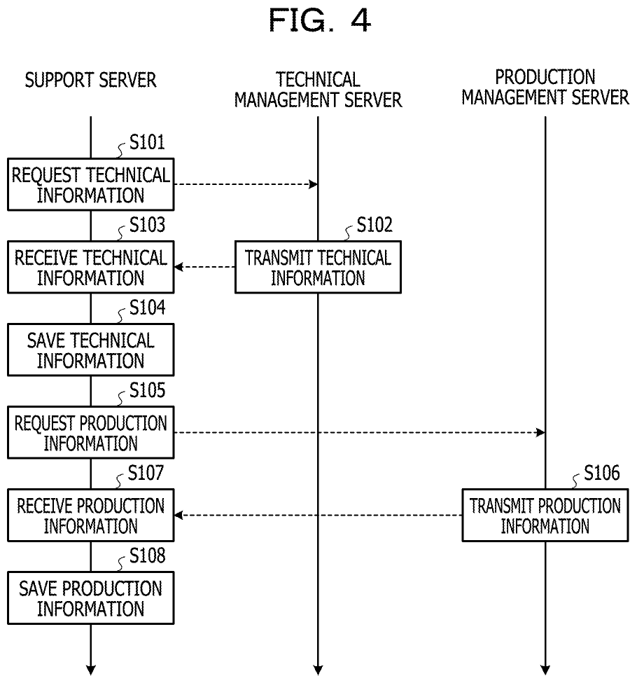

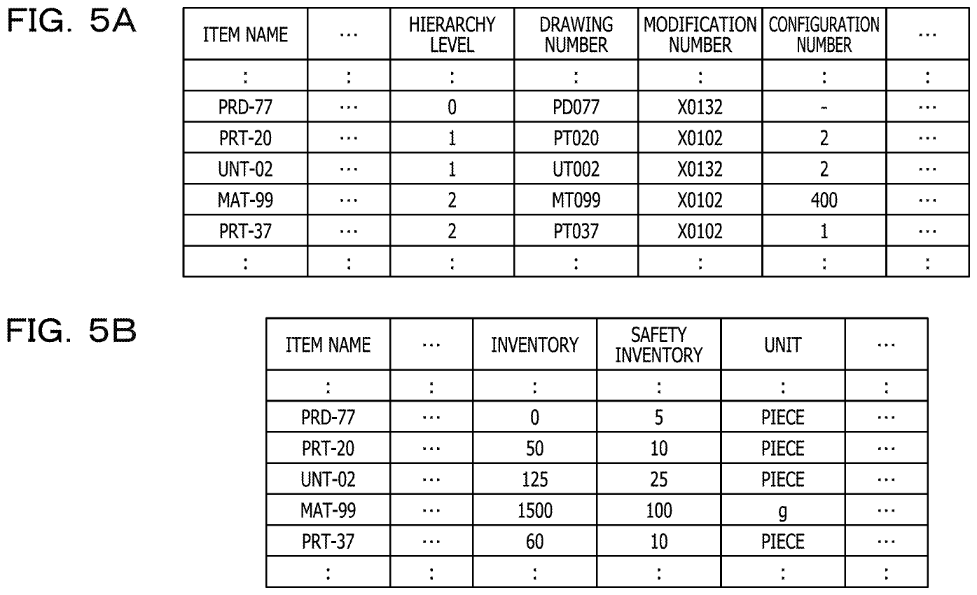

With reference to FIG. 4 and FIGS. 5A and 5B, operations of the support server 200, the technical management server 250, and the production management server 270 will be described next. FIG. 4 is an example of a first process sequence diagram. FIG. 5A illustrates an example of technical information. FIG. 5B illustrates an example of production information. As illustrated in FIG. 4, the information collection unit 221 of the support server 200 regularly requests the technical management server 250 to transmit technical information (step S101). When a request for technical information from the information collection unit 221 is given to the technical management server 250, a communication unit (not illustrated) of the technical management server 250 transmits the technical information (step S102). Thus, the communication unit 230 of the support server 200 receives the technical information (step S103). When the communication unit 230 receives the technical information, the information collection unit 221 obtains the technical information from the communication unit 230 and saves the technical information in the collected information storage unit 211 (step S104). As a result, the collected information storage unit 211 stores the technical information including design information before a design change. In such a way, the information collection unit 221 collects technical information.

The technical information, as illustrated in FIG. 5A, includes various fields such as an item name field, a hierarchy level field, a drawing number field, a modification number field, and a configuration count field. In the item name field, names identifying products and configuration items are registered. The name of a product or configuration item may include at least one of a character, a numeral, and a symbol. In the hierarchy level field, hierarchy levels at which configuration items are used are registered. For example, a hierarchy level “2” is registered for configuration items corresponding to materials including screws and bolts, terminal parts such as plate materials, adhesives and paints. A hierarchy level “1” is registered for configuration items corresponding to intermediate parts such as finished products in which two plate materials are fixed by four screws and assembled. A hierarchy level “0” is registered for products that are manufactured by using configuration items.

In the drawing number field, identifiers identifying design drawings of products and configuration items provided with item names are registered as drawing numbers. In the modification number field, an identifier identifying the version of a design drawing is registered as a modification number. These identifiers may be combinations of numerical values and characters or combinations of a plurality of numerical values. In the configuration count field, the amount or weight of each configuration item required for completing a product is registered. For example, it is indicated that, for the configuration item with an item name “UNT-02”, two configuration items are required for completion of the product. It is indicated that, for the configuration item with an item name “MAT-99”, 400 g of the configuration item is required for completion of the product. In addition, the technical information includes various fields, in each of which information corresponding to the field is registered.

Referring back to FIG. 4, upon completion of the processing in step S104, the information collection unit 221 of the support server 200 regularly requests the production management server 270 to transmit production information next (step S105). When a request for production information from the information collection unit 221 is given to the production management server 270, a communication unit (not illustrated) of the production management server 270 transmits the production information (step S106). Thus, the communication unit 230 of the support server 200 receives the production information (step S107). When the communication unit 230 receives the production information, the information collection unit 221 obtains the production information from the communication unit 230 and saves the production information in the collected information storage unit 211 (step S108). As a result, the collected information storage unit 211 stores the production information. In such a way, the information collection unit 221 collects production information.

The production information, as illustrated in FIG. 5B, includes various fields such as an item name field, an inventory field, a safety inventory field, and a unit field. In the item name field, names identifying items such as parts, materials, and products are registered as described above. In the inventory field, the amount of an item in inventory, the item being provided with an item name, is registered. In the safety inventory field, for an item provided with an item name, the minimum amount of the item in inventory to be secured is registered. In the unit field, the unit of the amount of an item in inventory is registered. In addition, the production information includes various fields, in each of which information corresponding to the field is registered. For example, the production information may include an item classification field, where a flag identifying whether a target configuration item is to be internally produced or to be purchased is registered.

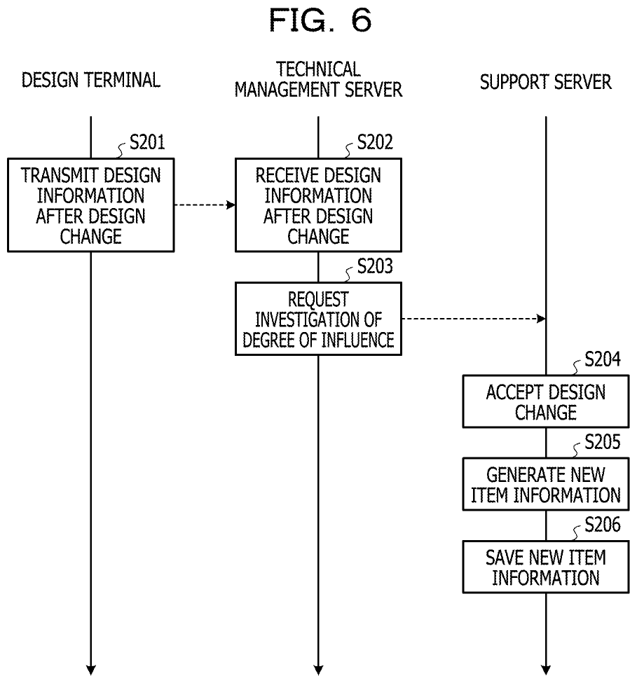

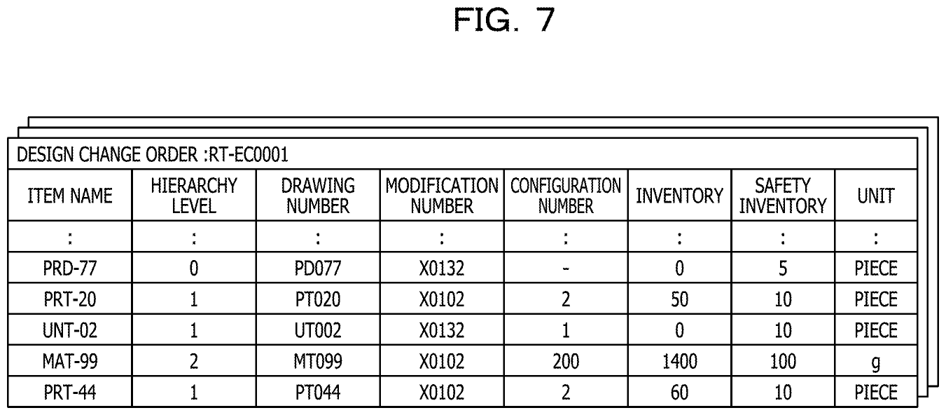

With reference to FIG. 6 and FIG. 7, operations of the design terminal 10, the support server 200, and the technical management server 250 will be described next. FIG. 6 is an example of a second process sequence diagram. The second process sequence diagram is a process sequence diagram following the first process sequence diagram. FIG. 7 illustrates an example of new item information. A communication unit (not illustrated) of the control device 13 included in the design terminal 10 transmits design information after a design change (step S201). Thus, the communication unit of the technical management server 250 receives the design information after the design change transmitted from the design terminal 10 (step S202). When the communication unit of the technical management server 250 receives the design information after the design change, a processing unit (not illustrated) of the technical management server 250 requests the support server 200 to investigate the degree of influence of the design change on the product (step S203). For example, the processing unit of the technical management server 250 manages the design information after the design change, and the communication unit transmits the received design information after the design change to the support server 200 to request investigation of the degree of influence. When the request for investigation of the degree of influence from the technical management server 250 is given, the accepting unit 222 accepts the design change (step S204). For example, the accepting unit 222 accepts the design change by obtaining the design information after the design change received by the communication unit 230. Upon accepting the design change, the accepting unit 222 generates a design change order as an identifier uniquely identifying the design information after the design change. Upon generating the design change order, the accepting unit 222 outputs the obtained design information after the design change and the generated design change order to the information generation unit 223.

Upon completion of the processing in step S204, the information generation unit 223 generates new item information (step S205) and saves the generated new item information (step S206). For example, the information generation unit 223 generates new item information in such a manner that the design information after the design change and the design change order, which are output from the accepting unit 222, are associated with each other. Thus, as illustrated in FIG. 7, the information generation unit 223 generates new item information including the design information after the design change and the design change order. In FIG. 7, the item name, the hierarchy level, the drawing number, the modification number, and the configuration count correspond to the design information after the design change. The inventory, the safety inventory, and the unit may or may not be included in the design information after the design change. If the inventory, the safety inventory, and the unit are included in the design information after the design change, the designer may include these items in the design information after the design change. The new item information includes a design change order “RT-EC0001” generated by the accepting unit 222. Upon generating new item information, the information generation unit 223 saves the generated new item information in the new item information storage unit 212. The new item information storage unit 212 stores new item information for each design change order. In such a way, each time the support server 200 receives design information after a design change from the technical management server 250, the support server 200 generates and manages new item information.

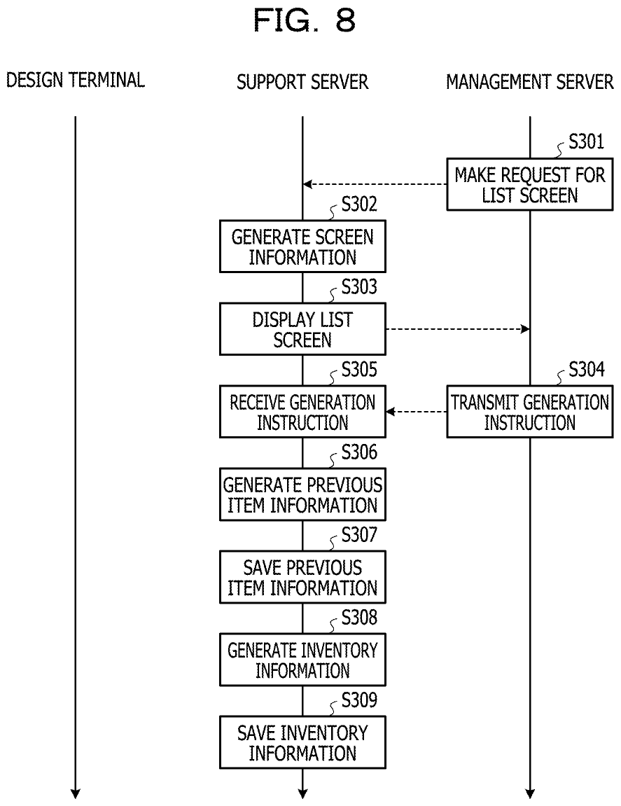

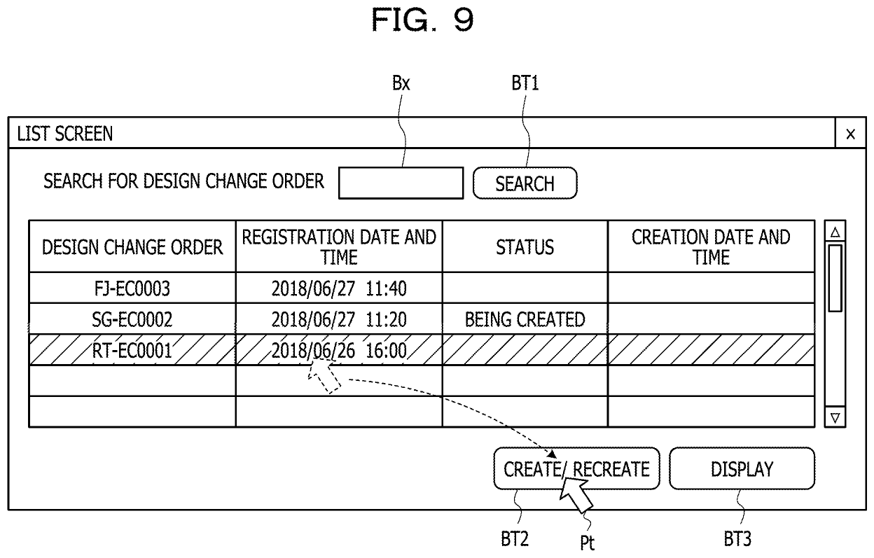

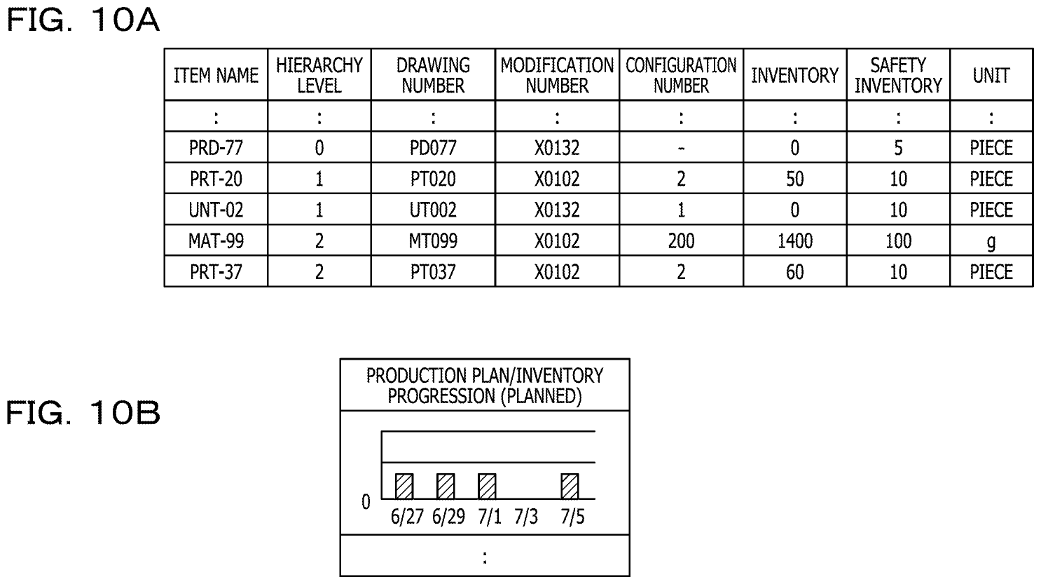

With reference to FIG. 8 to FIGS. 10A and 10B, operations of the management terminal 100 and the support server 200 will be described next. FIG. 8 is an example of a third process sequence diagram. The third process sequence diagram is a process sequence diagram following the second process sequence diagram. FIG. 9 illustrates an example of a list screen. FIG. 10A illustrates an example of previous item information. FIG. 10B illustrates an example of inventory information. First, as illustrated in FIG. 8, the control unit 132 of the control device 130 included in the management terminal 100 requests, via the communication unit 131, the support server 200 to provide a list screen (step S301). When the request for a list screen from the control unit 132 is given to the screen generation unit 224 of the support server 200, the screen generation unit 224 generates screen information on the list screen (step S302). For example, the screen generation unit 224 obtains a design change order from the new item information storage unit 212 and generates screen information including the obtained design change order.

Upon completion of the processing in step S302, the screen generation unit 224 displays the list screen on the display device 120 included in the management terminal 100 (step S303). For example, the communication unit 230 obtains the screen information generated by the screen generation unit 224 and transmits the obtained screen information to the management terminal 100. The communication unit 131 of the control device 130 receives the screen information transmitted by the communication unit 230 and outputs the received screen information to the control unit 132. The control unit 132 displays the list screen on the display device 120 based on the screen information output from the communication unit 131. Thus, as illustrated in FIG. 9, the display device 120 displays the list screen.

The list screen includes design change orders of new item information that is managed in the support server 200. Thus, the manager may confirm a case where investigation of the degree of influence is requested. The list screen also includes, as registration date and time, the date and time when new item information has begun to be managed by the support server 200. In addition, the list screen includes an edit box Bx, an operation button BT1, an operation button BT2, and an operation button BT3. The edit box Bx is an area for entering a search key in searching for a design change order. The operation button BT1 is an image for issuing an instruction for a search. The operation button BT2 is an image for issuing an instruction for generation of previous item information and inventory information. The operation button BT3 is an image for issuing an instruction for display of the first support screen and a second support screen described later.

As illustrated in FIG. 9, the manager may select, with a pointer Pt, any one of the design change orders included in the list screen by using the input device 110 and perform an operation of depressing the operation button BT2. For example, the manager may select a design change order for which no string is displayed in the status field included in the list screen. Thus, as illustrated in FIG. 8, the communication unit 131 transmits a generation instruction to the support server 200 (step S304). For example, when the control unit 132 detects the depressing of the operation button BT2, the communication unit 131 transmits a generation instruction for instructing that previous item information and inventory information be generated. Thus, the communication unit 230 of the support server 200 receives the generation instruction transmitted from the management terminal 100 (step S305). The generation instruction includes the design change order selected with the pointer Pt.

When the communication unit 230 receives the generation instruction, the information generation unit 223 generates previous item information (step S306) and saves the generated previous item information (step S307). For example, the information generation unit 223 searches the new item information storage unit 212 based on the design change order included in the generation instruction and extracts new item information associated with the design change order. Upon extracting the new item information, the information generation unit 223 identifies an item name at the hierarchy level “0” among a plurality of item names of the extracted new item information. The information generation unit 223 obtains, from the collected information storage unit 211, technical information and production information that include the same item name as the identified item name. The information generation unit 223 also obtains, from the collected information storage unit 211, technical information and production information that include the item name of a configuration item for use in a product corresponding to the identified item name.

In the present embodiment, since the design change order “RT-EC0001” is selected, the information generation unit 223 extracts new item information associated with the design change order “RT-EC0001” (refer to FIG. 7). The information generation unit 223 then identifies an item name “PRD-77” at the hierarchy level “0” among a plurality of item names of the extracted new item information. The information generation unit 223 then obtains, from the collected information storage unit 211, technical information (refer to FIG. 5A) and production information (refer to FIG. 5B) that include the item name “PRD-77”. The information generation unit 223 also obtains, from the collected information storage unit 211, technical information (refer to FIG. 5A) and production information (refer to FIG. 5B) that include item names “PRT-20”, . . . , “PRT-37” of configuration items for use in a product corresponding to the item name “PRD-77”.

Upon obtaining the technical information and the production information, the information generation unit 223 generates previous item information based on the obtained technical information and production information. For example, the information generation unit 223 selects some elements required for screen display from the obtained technical information and production information and generates previous item information in which the selected elements are associated with each other. Thus, the information generation unit 223 generates previous item information as illustrated in FIG. 10A. As illustrated in FIG. 10A, the previous item information includes a part of the technical information (refer to FIG. 5A) and a part of the production information (refer to FIG. 5B). For example, a part of the technical information corresponds to design information. In such a way, based on the technical information and production information stored in the collected information storage unit 211, the information generation unit 223 may generate previous item information. Upon generating the previous item information, the information generation unit 223 saves the generated previous item information in the previous item information storage unit 213. Thus, the previous item information storage unit 213 stores previous item information (refer to FIG. 10A).

Upon completion of the processing in step S307, the information generation unit 223 subsequently generates inventory information (step S308) and saves the generated inventory information (step S309). For example, based on production information stored in the collected information storage unit 211, the information generation unit 223 first determines, for each of configuration items that are used before and after a design change, whether the configuration count of the configuration item after the design change decreases from the configuration count of the configuration item before the design change. Then, the information generation unit 223 generates inventory information for a configuration item whose configuration count after a design change decreases from the configuration count before the design change. For example, the information generation unit 223 generates inventory information for a configuration item that is expected to have a surplus of inventory due to a design change.

The inventory information, as illustrated in FIG. 10B, includes a line graph indicating inventory progression in a production plan at the current time (for example, on the day of operation or on the day following the day of operation) and a bar graph indicating production volumes of a configuration item. In the graphs, the horizontal axis represents the calendar at and after the current time and the vertical axis represents the amount of the configuration item. For example, the line graph represents the total amount of inventory of a configuration item and the bar graph represents the amount of the configuration item produced on the day. Although the amount of a configuration item is illustrated once in every two days in the present embodiment, the amount may be illustrated once every day or once every half day. The information generation unit 223 generates such inventory information and saves the inventory information in the previous item information storage unit 213. Thus, the previous item information storage unit 213 stores the inventory information of a configuration item that is expected to have a surplus of inventory due to a design change. Upon completion of the processing in step S309, in FIG. 9, a string “CREATED” is displayed in the status field corresponding to the design change order selected with the pointer Pt.

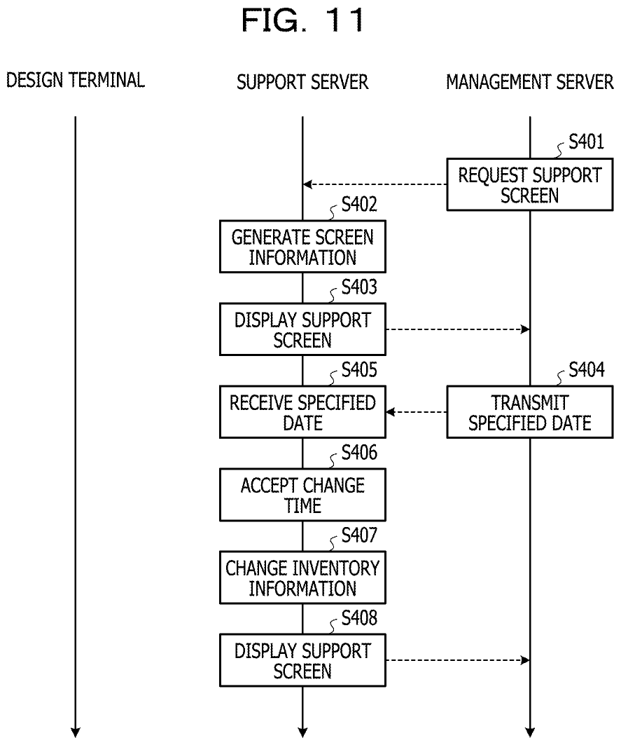

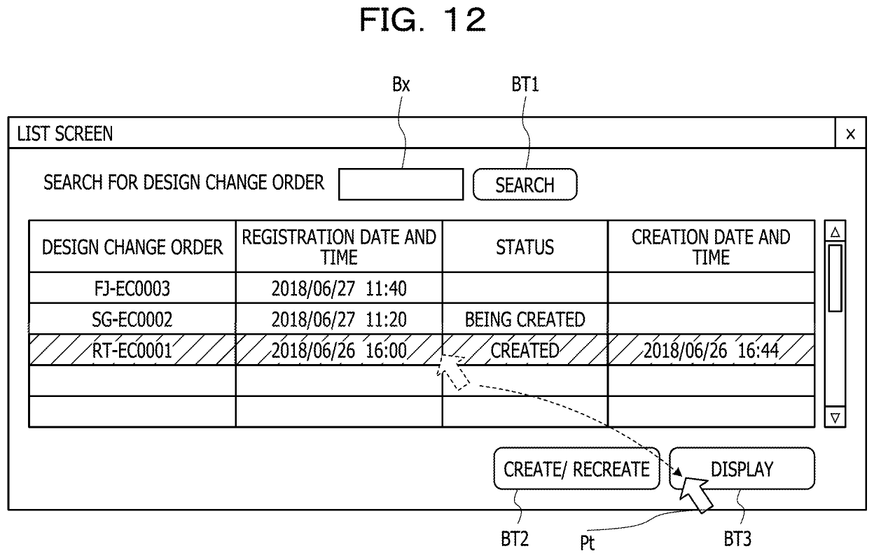

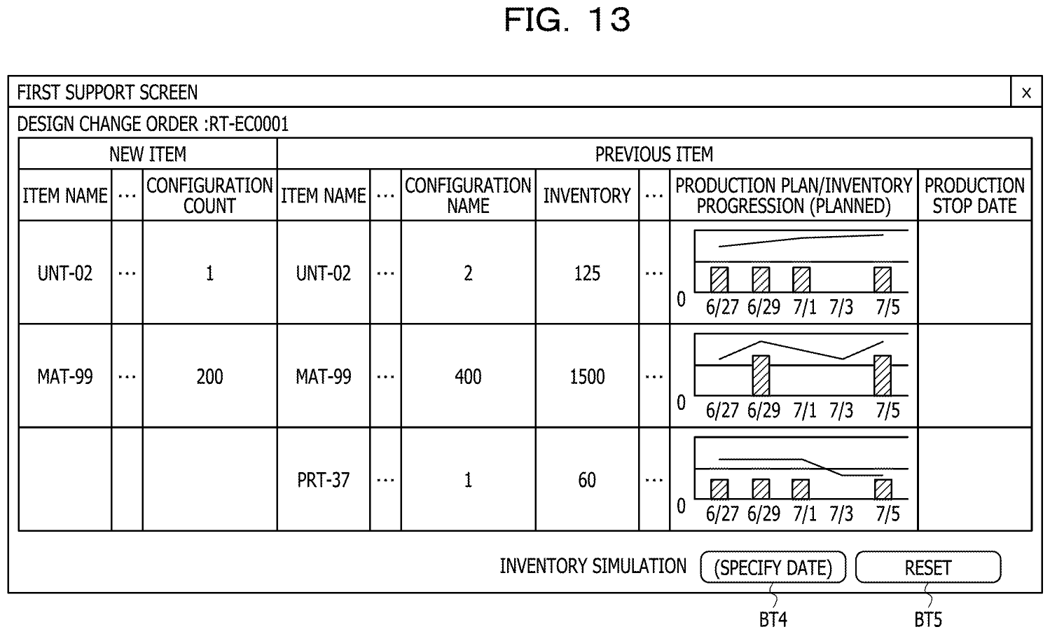

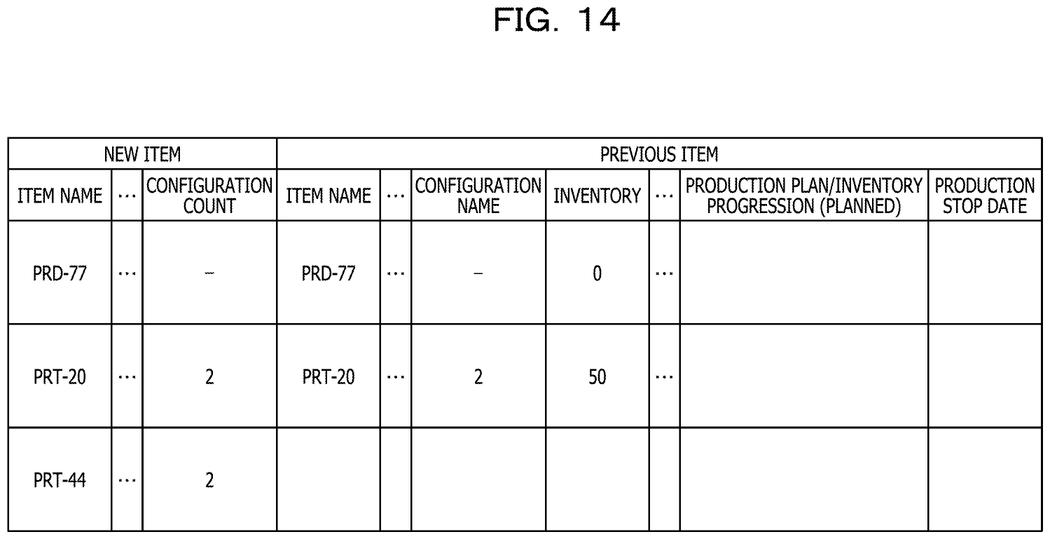

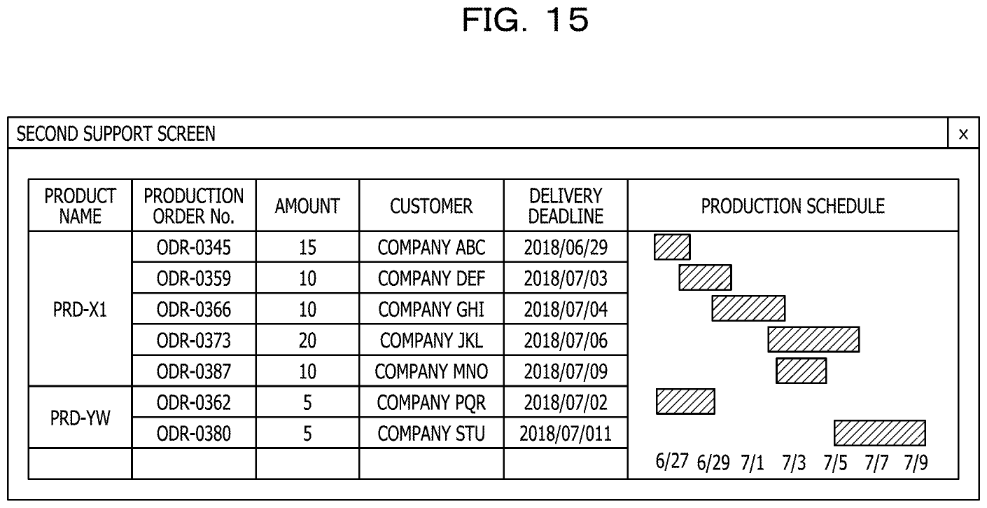

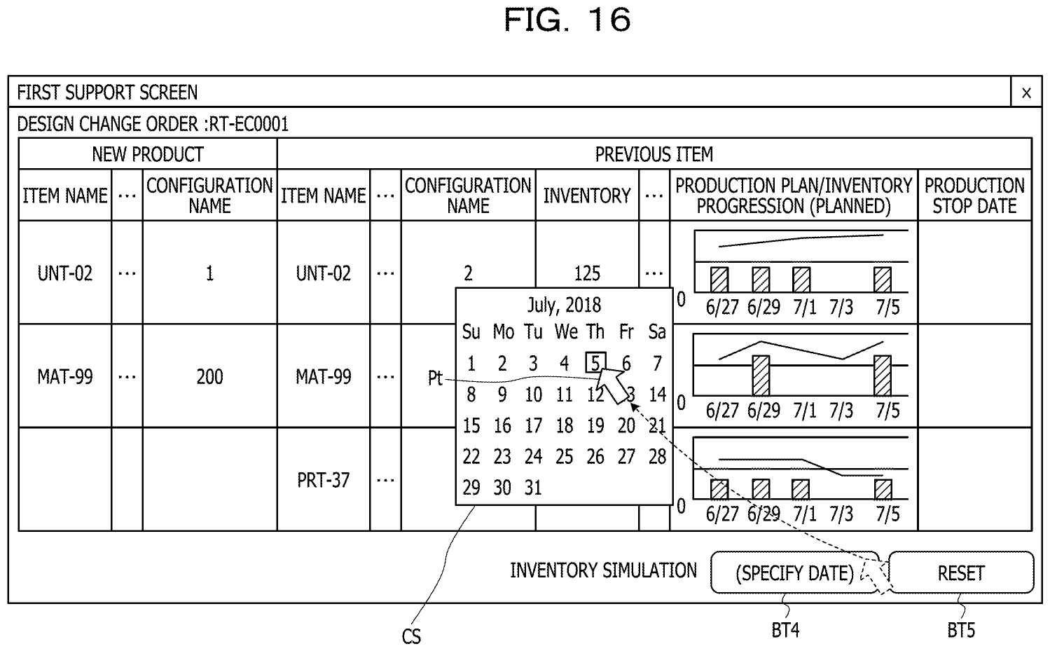

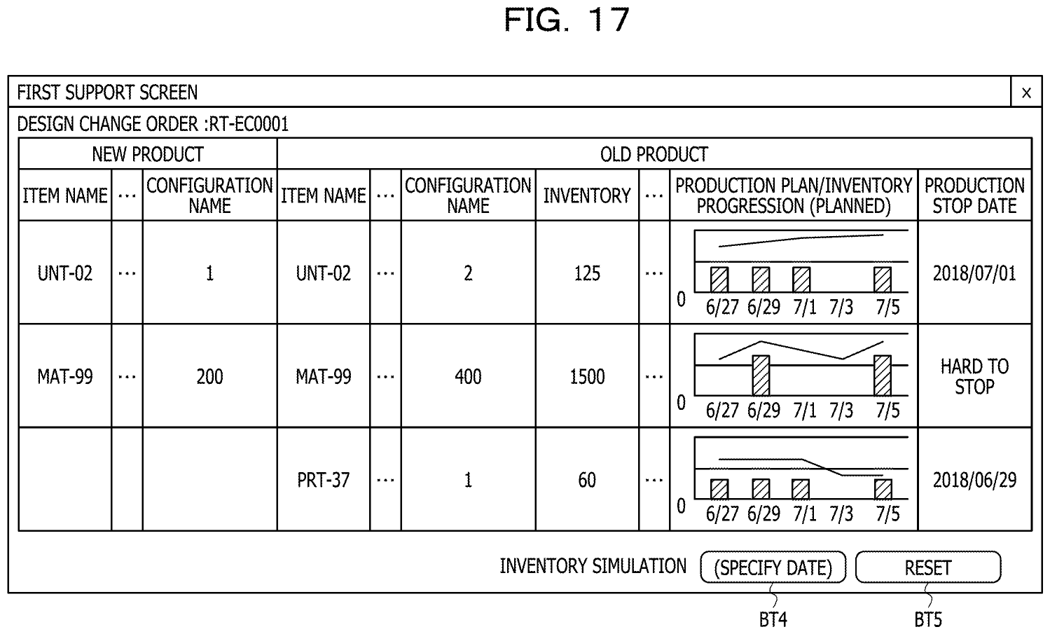

FIG. 11 is an example of a fourth process sequence diagram. The fourth process sequence diagram is a process sequence diagram following the third process sequence diagram. FIG. 12 illustrates another example of the list screen. FIG. 13 illustrates an example of the first support screen before inventory information is changed. FIG. 14 illustrates an example of new item information and previous item information for which inventory information is not generated. FIG. 15 illustrates an example of the second support screen. FIG. 16 is a diagram illustrating an example of operations for determining a specified date. FIG. 17 illustrates an example of the first support screen after inventory information is changed.

First, as illustrated in FIG. 11, the control unit 132 of the control device 130 included in the management terminal 100 requests, via the communication unit 131, the support server 200 to provide a support screen (step S401). For example, as illustrated in FIG. 12, the manager first operates the input device 110 to select, with the pointer Pt, a design change order for which the string “CREATED” is displayed in the status field included in the list screen. Then, the manager performs an operation of depressing the operation button BT3 with the pointer Pt. Thus, the control unit 132 requests the support server 200 to provide a support screen.

When the request for the support screen from the control unit 132 is given to the screen generation unit 224 of the support server 200, the screen generation unit 224 generates screen information on the support screen (step S402). For example, the screen generation unit 224 obtains new item information from the new item information storage unit 212. The screen generation unit 224 also obtains previous item information and inventory information from the previous item information storage unit 213. Upon obtaining the new item information, the previous item information, and the inventory information, the screen generation unit 224 generates screen information on the first support screen described later based on the obtained new item information, previous item information, and inventory information. For example, the screen generation unit 224 generates screen information on the first support screen in such a manner that the new item information, the previous item information, and the inventory information are aligned for each of products and configuration items. The screen generation unit 224 identifies an item name at the hierarchy level “0” among a plurality of item names of the previous item information and obtains production information including the identified item name from the collected information storage unit 211. Based on the obtained production information, the screen generation unit 224 generates screen information on the second support screen described later.

Upon completion of the processing in step S402, as illustrated in FIG. 11, the screen generation unit 224 displays the support screen on the display device 120 included in the management terminal 100 (step S403). For example, the communication unit 230 obtains the screen information on the first support screen and the screen information on the second support screen from the screen generation unit 224 and transmits the obtained two pieces of screen information to the management terminal 100. In the management terminal 100, upon the communication unit 131 receiving the two pieces of screen information, the control unit 132 displays the first support screen and the second support screen on the display device 120 based on the two pieces of screen information received by the communication unit 131.

The first support screen, as illustrated in FIG. 13, includes a design change order selected with the pointer Pt. The first support screen also includes new item information, previous item information, and inventory information. In FIG. 13, illustrations of the new item information and the previous item information are partially omitted. The new item information is displayed below a label “NEW ITEM” positioned on the left side of the first support screen. The previous item information and the inventory information are displayed below a label “PREVIOUS ITEM” positioned on the right side of the first support screen. The new item information and the previous item information are displayed side by side for each of configuration items that are used before and after a design change. Thus, the manager may easily compare the new item information with the previous item information. For example, by confirming that the configuration count of the new item decreases from the configuration count of the previous item, the manager may assume that there will be inventory after the design change.

When a configuration item in the previous item information before a design change is absent in the new item information after the design change, the field of the corresponding configuration item in the new item information is displayed as a blank. The reason is that the target configuration item becomes unnecessary after the design change of the product. Accordingly, by confirming that a configuration item as the previous item before a design change will not be used after the design change, the manager may assume that there will be inventory after the design change. In addition, the first support screen includes an operation button BT4 and an operation button BT5. The operation button BT4 is an image for running a simulation until inventory of a configuration item in the previous item information is completely consumed on a specified date. For example, the operation button BT4 is an image for running a simulation until the inventory progression has a value of zero on a specified date. The operation button BT5 is an image for removing a simulation result.

Between the new item information, previous item information, and inventory information and the operation button BT4 and operation button BT5 illustrated in FIG. 13, the new item information and previous item information for which no inventory information is generated may be included as illustrated in FIG. 14. As illustrated in FIG. 14, when the configuration count is not changed before and after a design change and when a configuration item is added after a design change, inventory information is not generated. When new item information and previous item information for which inventory information is not generated are included, the order of arrangement of products and configuration items may be changed as appropriate. For example, the new item information and the previous item information at the hierarchy level “0” may be displayed immediately below the label “NEW ITEM” and the label “PREVIOUS ITEM”, and subsequently new item information and previous item information may be displayed in ascending order of the numerical value of a hierarchy level. The new item information and previous item information for which no inventory information is generated may be displayed on another first support screen different from the current first support screen.

In contrast, the second support screen, as illustrated in FIG. 15, includes the product name of a product manufactured by the manufacturing company MKR, a production identification number identifying an order of the product, the production volume, the name of a customer to whom the product is to be delivered, a delivery deadline, and a production schedule. The screen content of the second support screen may be included in the first support screen. For example, the screen content of the second support screen may be included immediately below the operation button BT4 and the operation button BT5 included in the first support screen. Thus, the manager may confirm at a glance products and configuration items before and after a design change and the order statuses of products affected by the design change.

As illustrated in FIG. 16, when the manager performs an operation of depressing, with the pointer Pt, the operation button BT4 included in the first support screen by using the input device 110, the control unit 132 displays a calendar screen CS on the display device 120. The manager performs an operation of specifying, with the pointer Pt, any day included in the calendar screen CS by using the input device 110. When the manager performs the operation, the control unit 132 identifies, as a specified date, the year and month that appears on the calendar screen CS and the day specified with the pointer Pt. When the control unit 132 identifies the specified date, as illustrated in FIG. 11, the communication unit 131 transmits the specified date to the support server 200 (step S404). Thus, the communication unit 230 of the support server 200 receives the specified date transmitted from the management terminal 100 (step S405).

When the communication unit 230 receives the specified date, the accepting unit 222 accepts a change time (step S406). For example, the accepting unit 222 accepts the specified date, which has been received by the communication unit 230, as a change time when a design change of a product is to be made. When the accepting unit 222 accepts the change time, the information generation unit 223 changes inventory information (step S407). For example, the information generation unit 223 obtains inventory information for each of configuration items from the previous item information storage unit 213 and changes the production volumes of the configuration items so that all the inventory progression of the configuration items is zero at the change time. Depending on the change time, all the inventory progression included in inventory information is not zero in some cases. In such cases, the information generation unit 223 changes the inventory progression of any one of the configuration items to be zero at the change time and changes the inventory progression of the remaining configuration items so that the inventory progression approaches zero at the change time.

Upon completion of the processing in step S407, as illustrated in FIG. 11, the screen generation unit 224 displays a support screen on the display device 120 included in the management terminal 100 (step S408). For example, the communication unit 230 obtains inventory information after the change from the information generation unit 223 and transmits the obtained inventory information after the change to the management terminal 100. In the management terminal 100, upon the communication unit 131 receiving the inventory information after the change, the control unit 132 updates inventory information of the first support screen based on the inventory information after the change received by the communication unit 131.

Thus, as illustrated in FIG. 17, the inventory information after the change appears as a simulation result in the first support screen. In the present embodiment, the specified date is Jul. 5, 2018, and therefore a change is made so that the right edge of the line graph of inventory progression is zero on the specified date. The display content of the operation button BT4 is changed to the specified date simultaneously with appearing of a simulation result, and therefore the manager may confirm a time when a design change of a product is to be made. For the configuration item with the item name “MAT-99”, the inventory progression is not zero on the specified date and therefore is changed so that the inventory progression approaches zero as described above.

With the first support screen illustrated in FIG. 17, the date on which it is desirable to stop producing a configuration item may be identified. For example, for the configuration item with the item name “UNT-02”, it is desirable to stop production on Jul. 1, 2018. Prior to the simulation, the configuration item with the item name “UNT-02” is planned to be produced on Jul. 1 and 5, 2018 in the same manner as on June 29th and earlier (refer to FIG. 13). However, as illustrated in FIG. 17, production of the configuration item with the item name “UNT-02” is stopped after a given amount of this configuration item is produced on Jul. 1, 2018. This enables the inventory of the configuration item to be zero on Jul. 5, 2018, which is the specified date. Such a date on which it is desirable to stop producing the configuration item appears in a production stop date field in the first support screen. If a design change of the configuration item is made on the date on which the inventory of the configuration item becomes zero, a design change of a product including the configuration item is made together. For a reason similar to the above, production of the configuration item with the item name “PRT-37” is stopped on Jun. 29, 2018 after a given amount of the configuration item is produced. This enables the inventory of the configuration item to be zero on July 5th.

For the configuration item with the item name“MAT-99”, it is hard to reduce the inventory to zero on July 5th. This means that the inventory is left for this configuration item in this case. The remaining inventory may be diverted for another product or may be disposed of. The manager may remove a simulation result and carry out another simulation so that the inventory is not left.

As described above, according to the first embodiment, the support server 200 includes the processing unit 220. The processing unit 220 includes the accepting unit 222, the information generation unit 223, and the screen generation unit 224. The accepting unit 222 accepts, at different timings, a design change of a product and a time when the design change is to be made. When the accepting unit 222 accepts the design change of the product, the screen generation unit 224 displays new item information and previous item information on configuration items of the product before and after the design change so as to allow for comparison between the new item information and the previous item information. The screen generation unit 224 also displays inventory information of, among configuration items before a design change, a configuration item whose inventory would be generated. In contrast, when the accepting unit 222 accepts the time when the design change is to be made, the information generation unit 223 changes the inventory information. In this case, the screen generation unit 224 displays the inventory information after the change. Thus, when the design of a product is to be changed, a support may be provided to the manager to determine a time when a design change is to be made. For example, if the manager operates the management terminal 100 to identify as a specified date a time when a design change of a product is to be made, a production stop date is presented from the support server 200. Therefore, the manager may take into account the production stop date to determine the time when the design change is to be made. The support server 200 secures technical information, production information, and the like in advance. This may reduce the time taken for generating previous item information and inventory information compared with the case where technical information and production information are collected at a timing at which the operation button BT2 is depressed and then the previous item information and the inventory information are generated.

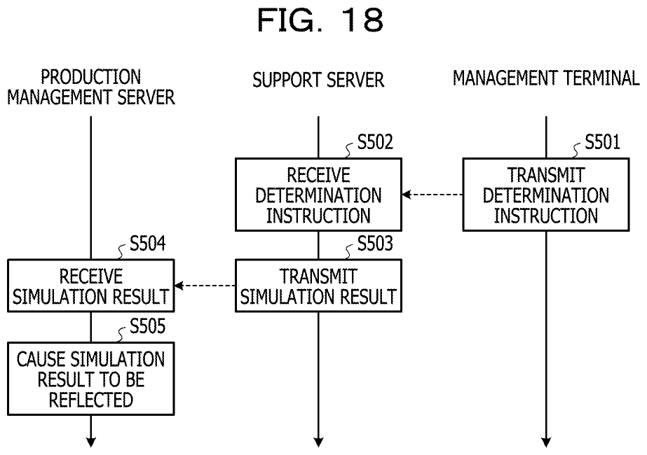

Subsequently, with reference to FIG. 18, a second embodiment of the present disclosure will be described. FIG. 18 is an example of a fifth process sequence diagram. The fifth process sequence diagram is a process sequence diagram following the fourth process sequence diagram. When the manager determines the time when a design change is to be made as a specified date, the manager performs a given operation on the input device 110 and thus, as illustrated in FIG. 18, the communication unit 131 transmits a determination instruction to the support server 200 (step S501). For example, another operation button (not illustrated) different from either of the operation button BT4 and the operation button BT5 may be provided in the first support screen. When the manager performs an operation of depressing the other operation button by using the input device 110, the communication unit 131 may transmit a determination instruction. Thus, the communication unit 230 of the support server 200 receives the determination instruction transmitted from the management terminal 100 (step S502).

Upon receiving the determination instruction, the communication unit 230 transmits a simulation result to the production management server 270 (step S503). The simulation result includes inventory information after a change including a specified date and a production stop date. Thus, the communication unit of the production management server 270 receives the simulation result transmitted from the support server 200 (step S504). When the communication unit of the production management server 270 receives the simulation result, a processing unit (not illustrated) of the production management server 270 causes production information managed by the production management server 270 to reflect the simulation result (step S505). For example, the production information is updated based on the simulation result. In such a manner, the support server 200 and the production management server 270 cooperate with each other, which enables production information of the production management server 270 to dynamically reflect inventory information after a change provided by the support server 200.

Although preferred embodiments according to the present disclosure have been described in detail above, the present disclosure is not limited to the specific embodiments, and various modifications and changes may be made within the scope of the essence of the present disclosure described in claims. For example, information presented to the manager with the first support screen may be changed as appropriate within the scope of the information stored in the collected information storage unit 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A production management support apparatus comprising:
a memory; and
a processor coupled to the memory and the processor configured to:
in response to receiving information indicating a design change of a product, display an image including both first information and second information, the first information regarding a first configuration of a first plurality of elements in the product before the design change, the second information regarding a second configuration of a second plurality of elements in the product after the design change,
perform display of inventory information of, among the first plurality of elements, a first element whose inventory is predicted to be generated due to the design change,
receive time information indicating a time when the design change is executed, and
based on the received time information, modify the inventory information of the first element into a modified inventory information of the first element.

2. The production management support apparatus according to claim 1, wherein
the processor is configured to perform a comparison between a first amount of the first element included in the first configuration and a second amount of the first element included in the second configuration.

3. The production management support apparatus according to claim 2, wherein
the display of inventory information is performed when it is determined by the comparison that the first amount is less than the second amount.

4. The production management support apparatus according to claim 1, wherein
the processor is configured to, based on the received time information, calculate a variation in an amount of the first element in inventory, and
the modified inventory information of the first element includes information representing the variation.

5. The production management support apparatus according to claim 1, wherein
the processor is configured to, based on the received time information and a daily production volume of the first element, determine a date on which production of the first element is stopped.

6. The production management support apparatus according to claim 1, wherein
the processor is configured to, in response to receiving an instruction indicating confirmation of the received time information, transmit the modified inventory information of the first element to a server that manages production of the product.

7. A computer-implemented production management support method comprising:
in response to receiving information indicating a design change of a product, displaying an image including both first information and second information, the first information regarding a first configuration of a first plurality of elements in the product before the design change, the second information regarding a second configuration of a second plurality of elements in the product after the design change;
displaying inventory information of, among the first plurality of elements, a first element whose inventory is predicted to be generated due to the design change;
receiving time information indicating a time when the design change is executed; and
based on the received time information, modifying the inventory information of the first element into a modified inventory information of the first element.

8. The production management support method according to claim 7, further comprising: performing a comparison between a first amount of the first element included in the first configuration and a second amount of the first element included in the second configuration.

9. The production management support method according to claim 8, wherein
the displaying of inventory information is performed when it is determined by the comparison that the first amount is less than the second amount.

10. The production management support method according to claim 7, further comprising: based on the received time information, calculating a variation in an amount of the first element in inventory,
wherein the modified inventory information of the first element includes information representing the variation.

11. The production management support method according to claim 7, further comprising: based on the received time information and a daily production volume of the first element, determining a date on which production of the first element is stopped.

12. The production management support method according to claim 7, further comprising: in response to receiving an instruction indicating confirmation of the received time information, transmitting the modified inventory information of the first element to a server that manages production of the product.

13. A non-transitory computer-readable medium storing instructions executable by one or more computers, the instructions comprising:
one or more instructions for, in response to receiving information indicating a design change of a product, displaying an image including both first information and second information, the first information regarding a first configuration of a first plurality of elements in the product before the design change, the second information regarding a second configuration of a second plurality of elements in the product after the design change;
one or more instructions for displaying inventory information of, among the first plurality of elements, a first element whose inventory is predicted to be generated due to the design change;
one or more instructions for receiving time information indicating a time when the design change is executed; and
one or more instructions for, based on the received time information, modifying the inventory information of the first element into a modified inventory information of the first element.
